(19) United States
(12) Patent Application Publication
(10) Pub. No.: US 2025/0211881 A1
(43) Pub. Date: Jun. 26, 2025

(54) Spectrum assignment in optical networks utilizing a minimum representative set and a topology agnostic approach

(71) Applicant: Ciena Corporation, Hanover, MD (US)

(72) Inventors: Zach Dunnigan, Ottawa (CA); Andrew D. Shiner, Ottawa (CA); Benoît Châtelain, Rosemere (CA)

(73) Assignee: Ciena Corporation, Hanover, MD (US)

(21) Appl. No.: 18/393,524

(22) Filed: Dec. 21, 2023

(51) Int. Cl. H04Q 11/00; H04J 14/02

(52) U.S. Cl. CPC H04Q 11/0066; H04J 14/0201; H04Q 2011/0086

(57) ABSTRACT

Spectrum assignment in an optical network utilizing a minimum representative set of constraints and a topology agnostic approach includes receiving network data associated with an optical network; identifying, from the network data, contention points and associated services that cross each contention point of the contention points; identifying spectral data at each contention point of the contention points; reducing the contention points and their associated spectral data to a subset of contention points, wherein a total number of the subset of contention points is less than a total number of the contention points; and utilizing the subset of contention points and their associated spectral data for assigning spectrum in the optical network. Each contention point is a fiber in the optical network or represents a functional limitation of an optical device, where any service thereon requires non-overlapping spectrum from any other service thereon.

### FIELD OF THE DISCLOSURE

The present disclosure relates generally to optical networks. More particularly, the present disclosure relates to systems and methods for spectrum assignment in optical networks utilizing a minimum representative constraint set and a topology agnostic approach.

### BACKGROUND OF THE DISCLOSURE

Routing, modulation, and spectral assignment (RMSA) is a complex problem in optical networks. In the past, this has been referred to as routing and wavelength assignment (RWA), such as in fixed-grid optical networks, and routing and spectral assignment (RSA) in flex-grid optical networks. The present disclosure utilizes the term RMSA to contemplate any and all approaches and the objective of all of these approaches is to find a wavelength or spectrum assignment for channels in the optical network, routed from a source to destination (as well as bi-directionally from the destination to source), considering some constraints. As described herein, the concepts of wavelength or spectrum assignment can be considered interchangeable, that is a channel needs to occupy a portion of spectrum from ingress to egress in the optical network. Also, the terms channels and services may be used interchangeably as well, i.e., a service or channel provides wavelength or spectrum connectivity between two points in the network. An obvious constraint is no two channels can share the same spectrum on the same fiber, i.e., this is considered spectral contention where these two channels would interfere with one another. Of course, there are other constraints as well, such as considering future growth, considering reserved spectrum, network configuration related constraints, etc. Also, contention on the same fiber is not merely confined to line fiber in an optical multiplex section (OMS) but can also be on intra-node fibers in a reconfigurable optical add/drop multiplexer (ROADM) as well as within equipment. Disadvantageously as network grow, as ROADM equipment becomes more complex with various configurations, and as constraints increase, the modeling necessary to perform RMSA becomes more complex to perform, especially with existing RMSA techniques. There is a need to make complex networks manageable, so that existing RMSA techniques can be leveraged.

### BRIEF SUMMARY OF THE DISCLOSURE

The present disclosure relates to systems and methods for spectrum assignment in optical networks utilizing a minimum representative constraint set and topology agnostic approach. In particular, the present disclosure includes various techniques to minimize the input data for RMSA processes, leveraging these processes with complex topologies. Key aspects of the present disclosure include:

(1) identification of so-called contention points which are fibers in the optical network where all services traversing a given contention point must have non-overlapping spectra. This identification is performed in an equipment or hardware topology agnostic manner.

(2) obtaining the spectrum at each contention point, including applying masking that captures differences between different entities reporting spectrum usage in the network.

(3) minimizing the contention points and their spectrum considering various techniques that reduce the number of contention points needed for analysis. For example, if two services share two contention points, these two contention points can be considered the same since they both have the same two services. This minimizing can reduce the number of points to analyze by one or more orders of magnitude.

(4) with the minimize set of contention points and their spectrum, utilizing existing RMSA processes, such as to perform spectrum assignments.

Of note, the terms minimize, minimal, minimum, optimal, optimum, etc. used herein do not necessarily have to refer to an absolute best value, but rather some improvement from values without the techniques described herein. For example, in a complex mesh optical network having hundreds or thousands of fiber links, spans, etc., the objective of the minimizing is to reduce the value to something less than every one of the hundreds or thousands of fiber links, spans, etc. That is, instead of hundreds or thousands of links, the reduction can be to hundreds or low thousands of links, which are easily processed by existing RMSA techniques.

Another key point is the aspect of contention points is they are based both on the (1) network topology and optical equipment and (2) the services being considered. That is, two identical networks from the perspective of topology and equipment will have different contention points based on different services. The idea of using services+topology/hardware allows reduction in the input data based on the assumption that no two services can overlap spectrally on the same fiber and an assumption that a superset link can be used to model any and all links that contain the same number or less of identical services. The reduction of contention points allows some contention points to be used to represent one or more additional contention points, thereby reducing the constraint set. With conventional approaches, the RMSA approach scales with both the number of links in the network and the number of services on the links. The present disclosure realizes an assumption that the number of links and number of services are related in that any link have the same services can be combined for purposes of the analysis, thereby enabling significant reduction in the input to any RMSA approach.

In various embodiments, the present disclosure includes a method having steps, an apparatus configured to implement the steps, and a non-transitory computer-readable medium storing instructions that, when executed, cause one or more processors to implement the steps. The steps include receiving network data associated with an optical network; identifying, from the network data, contention points and associated services that cross each contention point of the contention points; identifying spectral data at each contention point of the contention points; reducing the contention points and their associated spectral data to a subset of contention points, wherein a total number of the subset of contention points is less than a total number of the contention points; and utilizing the subset of contention points and their associated spectral data for assigning spectrum in the optical network.

Each contention point of the contention points can represent a fiber in the optical network where any service thereon requires non-overlapping spectrum from any other service thereon, and wherein the fiber can be one of a line fiber, an intra-node fiber in a node in the optical network, and a fiber within equipment at a corresponding node in the optical network. The identifying the contention points can utilize a graph to represent services where each vertex in the graph represents a link in the network and each edge represents relationships between vertices in the graph and where the graph is traversed to identify locations where more than one service share a vertex. The receiving network data can be from different sources, including at least network elements and a management system, and wherein the identifying spectral data at each contention point includes a step of masking out spectrum for each contention point where associated spectrum shows up as in use by any of the different sources.

The reducing the contention points and their associated spectral data can include identifying where multiple contention points are representable by a single contention point. The reducing the contention points and their associated spectral data can include one or more of combining a first plurality of contention points into a first single contention point where all of the first plurality of contention points have same services thereon, and combining a second plurality of contention points into a second single contention point where the second single contention point includes a superset of all services on all of the second plurality of contention points. The assigning spectrum can be for defragmenting the network where one or more services are recolored to change spectrum.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of an example optical network.

FIG. 2 is a flowchart of a process for determining a minimal representative set of an optical network for purposes of spectral assignment.

FIG. 3 is a graph illustrating a ROADM node.

FIG. 4 is a graph illustrating a topology climb graph based on the highlighted link from FIG. 3.

FIG. 5 is a graph illustrating an example of a typical layer rate stack.

FIG. 6 is a block diagram of a server.

### DETAILED DESCRIPTION OF THE DISCLOSURE

Again, the present disclosure relates to systems and methods for spectrum assignment in optical networks utilizing a minimum representative set and hardware agnostic approach.

### Optical Network

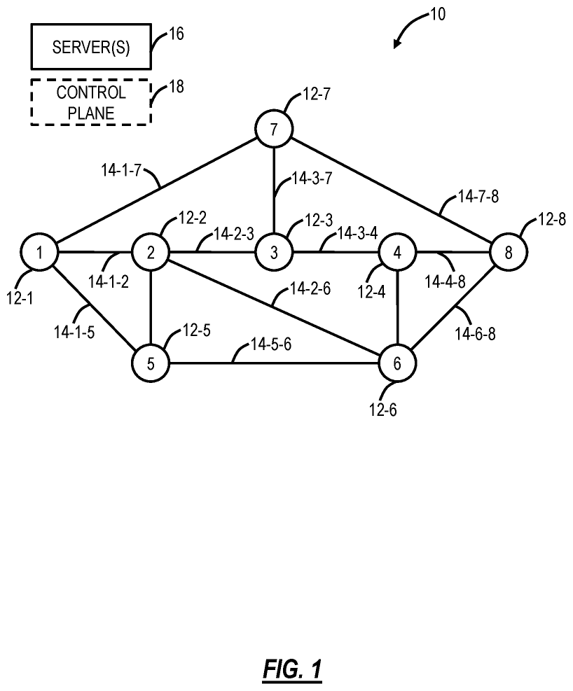

FIG. 1 is a network diagram of an example optical network 10. The optical network 10 includes nodes 12, labeled as nodes Dec. 1, 2012-8, interconnected to one another via links 14 which physically can include one or more optical fibers. The nodes 12 can also be referred to as network elements and can include, without limitation, Wavelength Division Multiplexing (WDM) terminals, DWDM terminals, Optical Add/Drop Multiplexers (OADMs), Reconfigurable OADMs (ROADMs), optical cross connects, optical switches, and the like. In various embodiments, the nodes 12 include various hardware and software to communicate with one another via wavelengths, as well as via timeslots (Time Division Multiplexing (TDM)), packets, etc. At a physical layer, the nodes 12 provide one or more wavelengths between one another over the links 14. Note, while FIG. 1 shows a single node 12 at each location, there can be multiple devices or network elements providing multiple wavelengths. For illustration purposes, each of the links is labeled as link 14-X-Y where X and Y are the nodes interconnected by the links 14. Note, the network 10 is a simple, small mesh network for illustration purposes, and those skilled in the art will appreciate practical examples can be one or more orders of magnitude larger in terms of nodes 12 and links 14.

The purpose of RMSA is to assign wavelengths or spectrum optimally across the links 14 in a manner that minimizes chances of blocking in the optical network 10. Blocking (or contention) means that a particular wavelength or spectrum is unavailable on one or more links, preventing a connection. Note that to route a service (without recourse to optical regeneration) the same wavelength (or in flexible grid same allocation of spectrum) must be free on all of the links making up the path between the two endpoints, or in the terms of the present disclosure, across all the contention points. Stated differently, RMSA answers the question of which route and wavelength or spectrum should be assigned to a particular A-Z connection in the network 10 in a manner that minimizes the chance of spectral contention or blocking either A-Z, other paths reliant on A-Z in whole or part, or wider portions of the network.

The optical network 10 can be communicatively coupled to one or more servers 16 and/or a control plane 18. The servers 16 can include or operate as, for example, a Software Defined Networking (SDN) controller, an SDN application, a Network Management System (NMS), an Element Management System (EMS), a planning tool, a Path Computation Element (PCE), etc. The control plane 18 provides an automatic allocation of network resources in an end-to-end manner. Examples of control planes may include Automatically Switched Optical Network (ASON) as defined in ITU-T G.8080/Y.1304, Architecture for the automatically switched optical network (ASON) (February 2012), the contents of which are herein incorporated by reference; Generalized Multi-Protocol Label Switching (GMPLS) Architecture as defined in IETF Request for Comments (RFC): 3945 (October 2004) and the like, the contents of which are herein incorporated by reference; Optical Signaling and Routing Protocol (OSRP) from Ciena Corporation which is an optical signaling and routing protocol similar to PNNI (Private Network-to-Network Interface) and MPLS; or any other type control plane for controlling network elements at multiple layers, and establishing connections. That is, the control plane 18 is configured to establish end-to-end signaled connections to route services and program the underlying hardware accordingly. SDN provides the management of network services through abstraction of lower-level functionality. This is done by decoupling the system that makes decisions about where traffic is sent (the control plane) from the underlying systems that forward traffic to the selected destination (the data plane).

Network topology is defined as the set of physical equipment and connections that constitute the network along with the provisioning of the network elements and any services. Topology also includes the nodal cross-connects, the control plane and any other aspects of the network hardware or software configuration.

### Conventional RMSA

RMSA can be performed for routing new services, i.e., which route and what spectrum should I use for a new service, as well as for defragmenting existing services, i.e., what services should I reroute and/or recolor (change spectrum) to obtain some improvement in the network. In all such cases, the RMSA processes must consider the contentions (no two services can share the same spectrum on the same fibers) and constraints in the optical network. There are two main issues related to conventional RMSA algorithms, namely (1) complexity and (2) topology issues. For complexity, RMSA algorithms can be NP-hard or NP-complete. Existing research has focused on heuristics, using reinforcement learning, genetic algorithms, etc. to provide optimal or near optimal solutions with less computational complexity. This becomes more difficult as the size of the networks grow as well as more spectrum being used as other bands are used (e.g., C+L band). That is, the size of the operation scales with the number of links and the number of services.

Some examples of existing RMSA approaches are described in U.S. Pat. No. 9,686,599, issued Jun. 20, 2017, and entitled “Minimal spectrum occupancy systems and methods for routing and wavelength or spectrum assignment in optical networks,” and U.S. Pat. No. 10,298,356, issued May 21, 2019, and entitled “Optimal partial reconfiguration of spectrum in optical networks,” the contents of each are incorporated by reference in their entirety. Of note, these existing algorithms can provide the correct answer and the present disclosure looks at reducing the input set into the algorithms through the contention points and associated reductions. That is, a focus of the present disclosure is not new RMSA techniques, but how to represent complex networks in a minimal fashion so that existing RMSA techniques are useable, efficiently, computationally reasonable, etc. We are showing an approach to take a complex input data set and resolve/reduce this data set based on various reduction techniques.

For topology, the existing approaches look at a fully resolved network topology, meaning an assumption that any problems have been resolved including any constraints introduced by missing or broken topology. As described herein, the network topology may come from different viewpoints including a network management system, the control plane, the network elements themselves, etc. There can be situations where there is a disconnect in the view of what spectrum is used or not. There are various reasons for having missing, broken, or orphan topology in the various platforms (NMS, planning tools, network elements themselves, SDN controllers, etc.) that monitor and manage the optical network. Topology which is not associated with a fully resolved end-to-end service may consume spectrum in parts of the network. For example, the NMS may report one view, whereas individual network elements may have slight differences, a controller or control plane may have spectrum reservations not included at every network element, etc. That is, a real network will have some occupied spectrum resulting from missing, broken, and/or orphaned topology.

Again, there are two general use cases for RMSA, namely adding new services and optimization/defragmentation, and both are contemplated with the approaches described herein. To add new services, an RMSA process is tasked with finding the route and the appropriate spectrum on that route for the new services, given the existing services, their spectrum, and other constraints as inputs. To defragment or optimize the network, an RMSA process is tasked with finding available spectrum to recolor and/or new routes to reroute existing services to achieve some objective (e.g., less blockage, more room for growth, more efficient use of spectrum, minimal changes for maximal improvement, etc.).

Of course, the challenges with complexity and topology issues are in both of these use cases of new services and defragmentation. In particular, with defragmentation, existing tools (e.g., NMS, planning systems, etc.) only consider fully resolved network topologies, i.e., assumes no issues, orphans, etc. This limits the ability of existing tools to validate path (route) and wavelength assignments are deployable in actual networks. Further, ROADM hardware configurations are complex and often include contention points internally to a given network element. That is, contention points are not merely optical line fibers, but can include intra-node fibers as well as points within modules in a node (ROADM).

Contentions or constraints resulting from broken or orphaned topology are simply ignored conventionally, resulting in routing solutions that may not be deployable. Also, there is a need to continually update the existing tools to deal with ever increasing hardware configurations.

### Minimum Representative Set, Hardware Agnostic Approach, and Masking of Spectrum

The present disclosure addresses these challenges in two interrelated aspects, namely (1) contention points and (2) spectral masks of the contention points. Again, contention points are topology points in the network where all services thereon have to be at non-overlapping spectrum. Here two services are defined as having non-overlapping spectrum if their modulated spectrums are sufficiently distinct such that the two services are able to operate without significant degradation resulting from encroachment of the modulated spectrum from one service into that of the other. Contention points are used to reduce the set of links that need to be analyzed by any RMSA process, using various reduction techniques. In this manner, any input to an RMSA process is far lower than the actual number of links and services in the network. The spectral masks are used to exclude any spectrum that is reserved, orphaned, broken, missing, etc., allowing the RMSA process to return a valid route and spectral assignment without having to troubleshoot and create a perfect topology.

### Contention Points

Contention points are places in the network where two or more services interact such that photons from one service co-propagate with photons form the one or more other services where it may not be possible to distinguish between photons from the two or more services following the co-propagation if they have the same wavelength. They can also be places where it is not possible for two services with the same or overlapping wavelength to simultaneously co-propagate.

Examples of contention points include line fibers (OMS or optical sections), intra-node fibers in a ROADM where multiple services are co-routed together (e.g., fiber interconnects between degrees, multiplexers, selective multiplexer/demultiplexer (SMD), wavelength selective switches (WSSs), etc.), as well as internal to some hardware components (i.e., similar to intra-node fibers but connections such as fibers inside equipment). From a modeling perspective, all of the contention points can be considered links in a network graph and the intra-node and internal hardware contention points can be viewed as virtual links in the network graph.

Services which pass through the same fiber must have different spectral occupancies to avoid contention. The fiber defines a contention point and all services that cross that contention point must have non-overlapping spectra. Contention points can be broadly understood as any point, physical or virtual, in the network which captures the relationship between services that are not permitted to spectrally overlap. In practice the set of ports traversed by a service is usually used to define the set of contention points.

The optical network 10 network can often be thought of as a mesh with different services travel together through different parts of the mesh. This is true for the transport Optically Managed Sections (OMSs) as well as for the internal connections within ROADM sites where services are aggregated as they route through the cards that comprise the ROADM and add/drop structures. While a given pair of services may only travel together as they pass through a small number of contention points, what matters is that they were together at some point and therefore must have distinct spectral assignments at all points in the network 10. This is a key observation—identifying that two services share just one contention point in the network means these services require distinct spectral assignments. This allows a significant reduction in the input data to the RMSA process.

When considering recoloring or rerouting services for defragmentation or for adding new services, it is necessary to consider all pairwise combinations of services that share common contention points. By identifying all pairs of services that share a common contention point, we can prevent contention without having to model the behavior of particular ROADM configurations.

Thus, one component of this disclosure is the recognition that often multiple contention points are associated with identical sets of services and that it is only necessary to keep one example to represent the contention. Furthermore, if a set of services at one contention point is a subset of the services at another contention point, it is only necessary to consider the superset. By consolidating contention points with identical sets of services and then rolling up contention points with sets that are subsets of those carried by other contention points we arrive at a small representative set. This representative set captures the contention between services which co-propagate anywhere in the network. It is this small representative set that needs to be analyzed for spectral assignments.

On example of a ROADM component that needs to be considered in the contention points is a degree module that performs a many-to-many mapping function, e.g., N×M where services can enter on one of N input ports and are routed to one of M output ports. Two services with the same wavelength cannot pass through the device even if they enter and exit on different ports. There is effectively an internal contention point within the device which is easily modeled by a synthetic point with the union of the services carried by all ports. These internal contention points can then be treated the same way as all other contention points.

### Masks

An additional concern when calculating defragmentation plans as well as routing new services is that real networks often have broken or orphaned topological elements which consumes spectrum along a route. Orphaned cross-connects are an example of this where a cross-connect is provisioned in a network element (NE) but is not recognized by the network orchestrator as being associated with a photonic service. These cross-connects are often not accounted for in routing or defragmentation calculations leading to solutions which will be rejected by the NE when attempting to provision a service which conflicts with the spectrum consumed by an existing cross-connect. To handle these cases, the occupied spectrum reported by all network elements at each contention point is considered along with the set of services that cross that contention point. The spectrum which the network considers to be in use is compared with the spectrum that can be accounted for based on the fully resolved services that are understood in the simulation environment to cross the contention point. A mask is defined from the difference between the reported and calculated spectra. Any spectrum which the network recognizes as in use that cannot be accounted for in terms of the resolved services is frozen. Defragmentation or service routing plans will not attempt to put services over top of the frozen spectrum. The reported spectrum at contention points with common services can be combined subject to various rules described herein.

By combining the sets of services at various contention points along with the reported spectrum at those points, we determine a representative set of services and a spectral mask which fully account for the service contentions and spectral occupancy at those points. The roll-up procedure dramatically reduces the number of contention points that need to be considered. For example, in a US national network there are almost 80,000 Physical Termination Points (PTPs) with non-zero reported capacity at layer zero. With the approach described herein, we can capture all contentions as well as the impact of broken or orphaned topology with just over 1500 (almost a 50× reduction) representative contention points. Those skilled in the art will recognize performing RMSA with 1500 constraints is a significant improvement over 80,000.

### Contention Points+Masks

The contention point analysis captures the relationships between services without having to consider the ROADM configurations. We know the connections between all equipment, and the services that cross each port. This leads to a simple and robust representation for contentions in the network which reduces to a small representative set. By combining the contention point analysis with the spectral occupancy reported by the network elements at each contention point, we produce a simulation environment that respects the constraints posed by imperfections in real networks.

Example contributions include:

(1) A mask that captures the difference between the spectrum that the network reports as occupied at each contention point and the spectrum that can be accounted for by the services and topology that are fully resolved in the simulation environment.

(2) A process for identifying the sets of services that co-propagate at each contention point.

(3) A process for aggregating and rolling up the services and reported spectrums from the contention points to arrive at a minimal representative set.

(4) A process that considers the constraints posed by the services crossing each contention point as well as the masked spectrum.

### Process

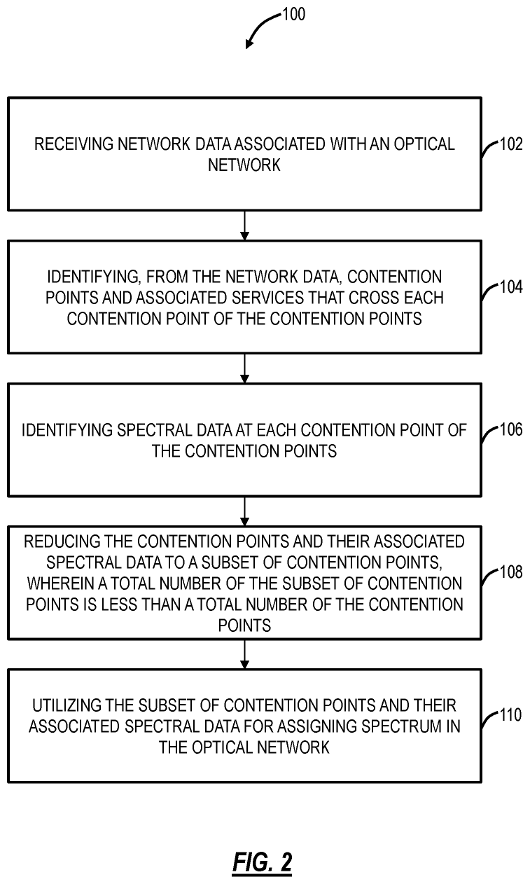

FIG. 2 is a flowchart of a process 100 for determining a minimal representative set of contention and spectral constraints for an optical network for purposes of spectral assignment. The process 100 contemplates implementation as a method having steps, via a processing device (e.g., an NMS, controller, planning tool, etc.) configured to implement the steps, and as a non-transitory computer-readable medium storing instructions that, when executed, cause one or more processors to implement the steps.

The process 100 includes receiving network data associated with an optical network (step 102), identifying, from the network data, contention points and associated services that cross each contention point of the contention points (step 104), identifying spectral data at each contention point of the contention points (step 106), reducing the contention points and their associated spectral data to a subset of contention points, wherein a total number of the subset of contention points is less than a total number of the contention points (step 108), and utilizing the subset of contention points and their associated spectral data for assigning spectrum in the optical network (step 110).

Each contention point of the contention points can represent a fiber in the optical network where any service thereon requires non-overlapping spectrum from any other service thereon, and wherein the fiber is one of a line fiber, an intra-node fiber in a node in the optical network, and a fiber within equipment at a corresponding node in the optical network. That is, the contention points are a way to model fibers for assigning spectrum.

The identifying the contention points can utilize a graph to represent services where each vertex in the graph represents a link in the network and each edge represents relationships between vertices in the graph and where the graph is traversed to identify locations where more than one service share a vertex.

The receiving network data can be from different sources, including at least network elements and a management system, and wherein the identifying spectral data at each contention point includes a step of masking out spectrum for each contention point where associated spectrum shows up as in use by any of the different sources. Note, masking is used where there is disagreement between the sources. If all the sources agree that a part of the spectrum is in use, it is not masked, but is marked as in use.

The reducing the contention points and their associated spectral data can include identifying where multiple contention points can be representable by a single contention point. The reducing the contention points and their associated spectral data can include one or more of combining a first plurality of contention points into a first single contention point where all of the first plurality of contention points have same services thereon, and combining a second plurality of contention points into a second single contention point where the second single contention point includes a superset of all services on all of the second plurality of contention points. The assigning spectrum can be for defragmenting the network where one or more services are recolored to change spectrum.

### Identifying Contention Points

In an embodiment, the network 10 can be modeled in a relational database (such as described in U.S. patent application Ser. No. 17/690,464, filed Mar. 9, 2022, and entitled “Lazy graph construction with compression and a hybrid graph-relational model for representing a network topology,” the contents of which are incorporated by reference in their entirety. Of course, other approaches are contemplated. In an embodiment, the present disclosure can utilize network modeling concepts described in the Open Networking Foundation (ONF) Core Information Model TR-512.1, version 1.3.1, January 2018, the contents of which are incorporated by reference in their entirety. The present disclosure can use Forwarding Relationship Encapsulation (FRE) and Termination Point Encapsulation (TRE). For this disclosure, we refer to network connections as FREs and the termination points for those connects as TPEs. Connections are made at a particular layer rate and multiple connections with different layer rates may terminate at the same TPE. An FRE at one layer rate relates to a set of connections at a lower layer rate through partition relationships if the set of lower FREs is directed, and decomposition relationships when the ordering is not important.

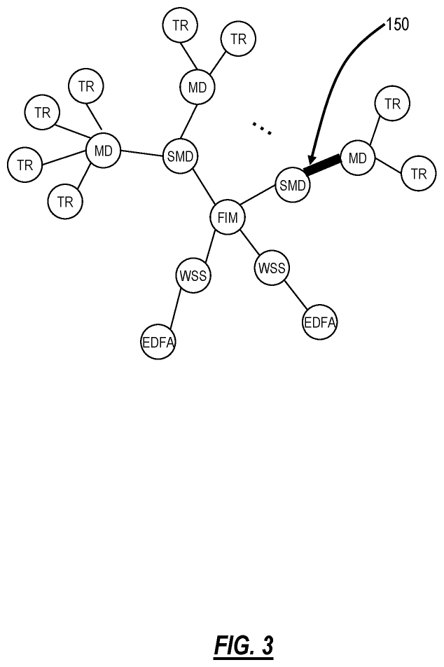

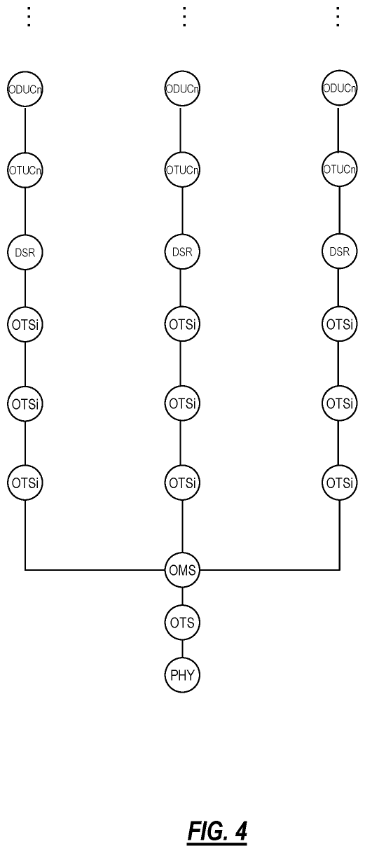

FIG. 3 is a graph illustrating a ROADM node. Here, the vertices represent different cards or module and the edges represent connections therebetween. For example, TR is a transceiver, MD is a multiplexer/demultiplexer, SMD is a selective multiplexer/demultiplexer (i.e., two levels of multiplexing/demultiplexing), FIM is a fiber interface module (e.g., a module for interconnecting the various cards or modules), WSS is a wavelength selective switch, EDFA is a line amplifier, etc. Specifically, FIG. 3 shows a way to represent any equipment for identifying contention points. In FIG. 3, there is a highlighted link 150 between two multiplexing/demultiplexing components. FIG. 4 is a graph illustrating a topology climb graph based on the highlighted link 150.

FIG. 4, at the bottom, starts with the physical connection (PHY) and climbs up to OTSi's and ultimately to individual services (not shown) that are carried on this fiber, associated with the highlighted link. This is the approach used to identify the services that cross a given fiber (i.e., contention point). DSR stands for Digital Service Rate.

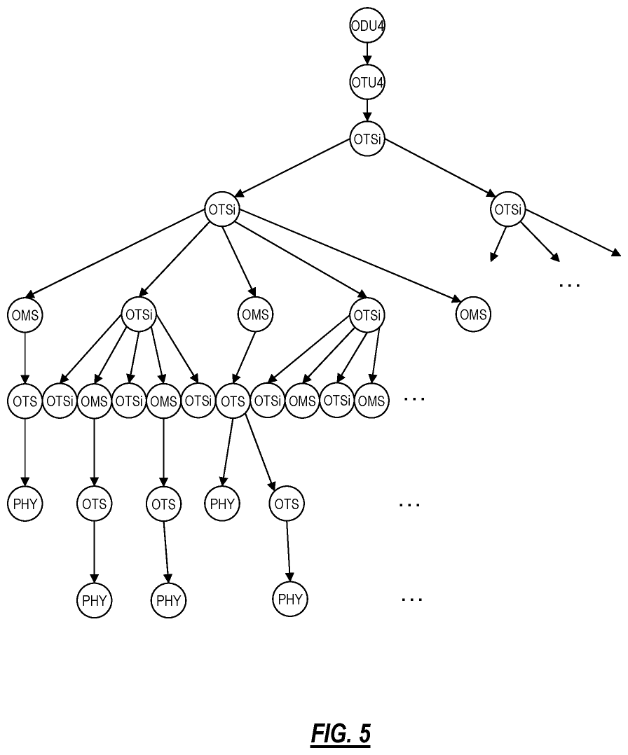

FIG. 5 is a graph illustrating an example of a typical layer rate stack. Here, this is a topology descend graph selected from one of the OTUCn's in FIG. 4. Here, FREs are represented with circles and the relationships to lower layer rate FREs are shown with arrows. In this example, the top ODU4 (Optical Data Unit level 4) FRE is a bi-directional photonic service. It partitions down through a second ODU4 and then to a bi-directional OTSi layer. The bi-directional OTSi (Optical Tributary Signal) decomposes into two uni-directional OTSi FREs.

In an embodiment, walking the graph can be used to identify contention points and the services that traverse them. For example, starting from the topology model identify all TPEs that correspond to physical layer ports (PTPs). These can be thought of as the faceplate ports that a fiber connects to. We also identify certain types of OTS termination points such as those which model termination of the individual fibers, such as in a multi-fiber push on (MPO) connection. Collectively, these are contention points. The FREs that terminate on each contention point are identified and then we climb up through the partition and decomposition relationships to find the zero or more bidirectional photonic FREs that are associated with each contention point. The set of bi-directional photonic service IDs that pass through each contention point are stored against the contention point.

In many cases the network element (NE) reports the spectrum which is in use at each contention point. This reported spectrum can also be stored against the contention point. Each contention point can be described by a tuple (contention ID, {bi-directional photonic service IDs}, [reported spectrum]). Again, based on equipment constraints, modeling contention at the physical ports is not sufficient and synthetic contention points are introduced to capture contention which occurs within a physical device or within a physical node. Again, an example of this is an N×M degree device which maps from N input ports to M output ports where the same wavelength cannot be reused on multiple ports. The synthetic contention point captures the set of services that cross any of the M or N ports and the reported spectrum is the logical OR of the contributions from all ports. We call this a synthetic contention point, but it acts the same as a contention point associated with a line fiber.

### Reduction

Many of the contention points described above are degenerate or their constraint is a subset of another contention point. The procedure for reducing the constraints to a minimal representative set is referred to as row-reduction which can include various steps including:
(1) Deduplication.
(2) Merging.
(3) Roll up.

The objective of all of these reduction steps is to reduce the number of contention points to a minimal set for ease of use later in RMSA processes, such as to assign spectrum.

For deduplication, we can keep only one contention point with each unique set of services and reported spectrum. For example, consider two contention points that have the same services and the same spectral masks, we can combine these, or, stated differently, we only need to keep one of these since satisfying one in terms of constraints for spectral assignments will by definition satisfy the other.

For merging, a given set of services that passes through multiple contention points with different reported spectrums will need to contend with the reported spectrum at each contention point. The same constraint is captured by combining the reported spectrums for all contention points that carry identical sets of services.

For roll up, if we consider two contention points A and B, it is possible to roll-up from A to B and only keep contention point B if and only if:

(1) All services carried by contention point A are also carried by contention point B.

(2) All spectrum that shows as occupied at contention point A also shows as occupied at contention point B.

An example of the roll up algorithm is given below:
Start with input[ ] with elements of the form:
(contention id, {service ids}, [reported spectrum], {roll_up_ids}) active set=0: len(input_set)
for test ix in Range (0, len(input))
   test if service ids in input[test ix] are a subset of the service ids in any input with index in active set that is not test_ix.
   Find first match where the reported spectrum in input[test ix] is fully contained in the reported spectrum of input[match ix].
   If a match is found:
      Add the input contention id at test ix to the set of
      roll up ids for input[match ix]
      Remove test ix from active set
output=input[active set]

### Defragmentation

The row reduced contention point and reported spectrum data can be used as part of a network defragmentation algorithm. At each row-reduced contention point, the spectrum that is occupied by the set of services which cross that contention point is calculated. That calculated spectrum is then compared to the reported spectrum. Any occupied regions of the reported spectrum which are not also occupied in the calculated spectrum correspond to spectrum which the NE sees as in use which are not accounted for by the defrag topology model. The difference between the reported and calculated spectrums is used to define a spectral mask which identifies regions of the spectrum at each contention point which services cannot be placed or moved into.

When recoloring a service, the algorithm confirms that the spectrum occupied by the service will not conflict with co-propagating services at any of the row-reduced contention points or overlap with any masked regions.

### Server

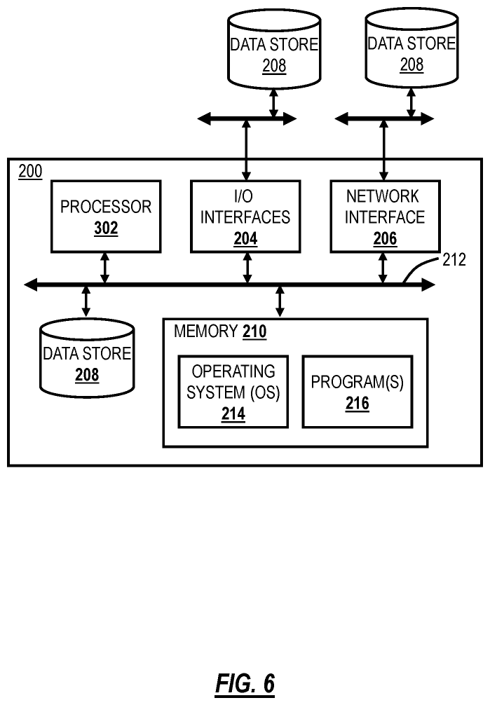

FIG. 6 is a block diagram of a server 200. The server 200 can implement a network management system, planning system, controller, etc. that is configured to implement the process 100. Also, one or more servers 200 can be configured together to form a cluster or some other grouping of compute resources configured to implement the process 100, such as Software-as-a-Service (Saas), via the cloud, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 6 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. A non-transitory computer-readable medium comprising instructions that, when executed, cause one or more processors to perform steps of:
receiving network data associated with an optical network;
identifying, from the network data, contention points and associated services that cross each contention point of the contention points;
identifying spectral data at each contention point of the contention points;
reducing the contention points and their associated spectral data to a subset of contention points, wherein a total number of the subset of contention points is less than a total number of the contention points; and
utilizing the subset of contention points and their associated spectral data for assigning spectrum in the optical network.

2. The non-transitory computer-readable medium of claim 1, wherein each contention point of the contention points represents a fiber in the optical network where any service thereon requires non-overlapping spectrum from any other service thereon, and wherein the fiber is one of a line fiber, an intra-node fiber in a node in the optical network, and a fiber within equipment at a corresponding node in the optical network.

3. The non-transitory computer-readable medium of claim 1, wherein the identifying the contention points utilizes a graph to represent services where each vertex in the graph represents a link in the network and each edge represents relationships between vertices in the graph and where the graph is traversed to identify locations where more than one service share a vertex.

4. The non-transitory computer-readable medium of claim 1, wherein the receiving network data is from different sources, including at least network elements and a management system, and wherein the identifying spectral data at each contention point includes a step of
masking out spectrum for each contention point where associated spectrum shows up as in use by any of the different sources.

5. The non-transitory computer-readable medium of claim 1, wherein the reducing the contention points and their associated spectral data includes identifying where multiple contention points are representable by a single contention point.

6. The non-transitory computer-readable medium of claim 1, wherein the reducing the contention points and their associated spectral data includes one or more of
combining a first plurality of contention points into a first single contention point where all of the first plurality of contention points have same services thereon, and
combining a second plurality of contention points into a second single contention point where the second single contention point includes a superset of all services on all of the second plurality of contention points.

7. The non-transitory computer-readable medium of claim 1, wherein the assigning spectrum is for defragmenting the network where one or more services are recolored to change spectrum.

8. A method comprising steps of:
receiving network data associated with an optical network;
identifying, from the network data, contention points and associated services that cross each contention point of the contention points;
identifying spectral data at each contention point of the contention points;
reducing the contention points and their associated spectral data to a subset of contention points, wherein a total number of the subset of contention points is less than a total number of the contention points; and
utilizing the subset of contention points and their associated spectral data for assigning spectrum in the optical network.

9. The method of claim 8, wherein each contention point of the contention points represents a fiber in the optical network where any service thereon requires non-overlapping spectrum from any other service thereon, and wherein the fiber is one of a line fiber, an intra-node fiber in a node in the optical network, and a fiber within equipment at a corresponding node in the optical network.

10. The method of claim 8, wherein the identifying the contention points utilizes a graph to represent services where each vertex in the graph represents a link in the network and each edge represents relationships between vertices in the graph and where the graph is traversed to identify locations where more than one service share a vertex.

11. The method of claim 8, wherein the receiving network data is from different sources, including at least network elements and a management system, and wherein the identifying spectral data at each contention point includes a step of
masking out spectrum for each contention point where associated spectrum shows up as in use by any of the different sources.

12. The method of claim 8, wherein the reducing the contention points and their associated spectral data includes identifying where multiple contention points are representable by a single contention point.

13. The method of claim 8, wherein the reducing the contention points and their associated spectral data includes one or more of
combining a first plurality of contention points into a first single contention point where all of the first plurality of contention points have same services thereon, and
combining a second plurality of contention points into a second single contention point where the second single contention point includes a superset of all services on all of the second plurality of contention points.

14. The method of claim 8, wherein the assigning spectrum is for defragmenting the network where one or more services are recolored to change spectrum.

15. An apparatus comprising:
one or more processors and memory storing instructions that, when executed, cause the one or more processors to
receive network data associated with an optical network,
identify, from the network data, contention points and associated services that cross each contention point of the contention points,
identify spectral data at each contention point of the contention points,
reduce the contention points and their associated spectral data to a subset of contention points, wherein a total number of the subset of contention points is less than a total number of the contention points, and
utilize the subset of contention points and their associated spectral data for assigning spectrum in the optical network.

16. The apparatus of claim 15, wherein each contention point of the contention points represents a fiber in the optical network where any service thereon requires non-overlapping spectrum from any other service thereon, and wherein the fiber is one of a line fiber, an intra-node fiber in a node in the optical network, and a fiber within equipment at a corresponding node in the optical network.

17. The apparatus of claim 15, wherein the identifying the contention points utilizes a graph to represent services where each vertex in the graph represents a link in the network and each edge represents relationships between vertices in the graph and where the graph is traversed to identify locations where more than one service share a vertex.

18. The apparatus of claim 15, wherein the receiving network data is from different sources, including at least network elements and a management system, and wherein the identifying spectral data at each contention point includes a step of
masking out spectrum for each contention point where associated spectrum shows up as in use by any of the different sources.

19. The apparatus of claim 15, wherein the reducing the contention points and their associated spectral data includes identifying where multiple contention points are representable by a single contention point.

20. The apparatus of claim 15, wherein the reducing the contention points and their associated spectral data includes one or more of
combining a first plurality of contention points into a first single contention point where all of the first plurality of contention points have same services thereon, and
combining a second plurality of contention points into a second single contention point where the second single contention point includes a superset of all services on all of the second plurality of contention points.
